(19) United States
(12) Patent Application Publication
(10) Pub. No.: US 2024/0250386 A1
(43) Pub. Date: Jul. 25, 2024

(54) BATTERY ARCHITECTURE, COMPRISING COMMON COMPONENTS, SUB-ASSEMBLIES, AND METHOD OF ASSEMBLING SAME

(71) Applicant: American Battery Solutions, Inc., Lake Orion, MI (US)

(72) Inventors: Erik William Anderson, Tory, MI (US); Shad Alan Kelly, Warren, MI (US); Michael Paul Garascia, Waterford, MI (US); Eric Walter Akkashian, Waterford, MI (US); Matthew Jon Knoche, Clarkston, MI (US); Joshua William Payne, Oakland Township, MI (US); Jean-Paul Ortiz, White Lake, MI (US)

(73) Assignee: American Battery Solutions, Inc., Lake Orion, MI (US)

(21) Appl. No.: 18/560,624

(22) PCT Filed: Feb. 23, 2022
(86) PCT No.: PCT/US2022/013016

§ 371 Date: Nov. 13, 2023

Related U.S. Application Data
(63) Continuation-in-part of application No. 17/319,170, filed on May 13, 2021.

(51) Int. Cl. H01M 50/503; H01M 10/42; H01M 10/6551; H01M 50/213; H01M 50/244; H01M 50/271; H01M 50/516; H01M 50/519

(52) U.S. Cl. CPC H01M 50/503; H01M 10/425; H01M 10/6551; H01M 50/213; H01M 50/244; H01M 50/271; H01M 50/516; H01M 50/519; H01M 2010/4271

(57) ABSTRACT

Systems and methods for a battery can comprise cells connected in parallel to form a group and groups of cells connected in series to form first and sub-assemblies with components suitable for multiple battery configurations. The first subassembly comprises a lower cell carrier and upper cell carrier between which the first groups of cells are disposed. The second subassembly comprises the lower cell carrier and upper cell carrier between which the second groups of cells are disposed. The flexible current collector comprises two or more conductive regions. The first and second subassemblies are connected in parallel or series to build the desired voltage or capacity of the battery. The flexible current collector is folded around the first and second subassemblies and disposed within casing to provide environmental protection to the battery, and positive and negative terminals connected to first and second conductive regions, respectively, to form positive and negative terminals of the battery.

### CROSS REFERENCE TO RELATED APPLICATION

This application claims priority to U.S. application Ser. No. 17/319,170, filed May 13, 2021, and is incorporated herein in its entirety.

### TECHNICAL FIELD

Embodiments of the present disclosure relate generally to an improved battery architecture, comprising modular components and sub-assemblies, and a method of manufacturing the same.

### BACKGROUND

Use of Original Equipment Manufacturer (“OEM”) Lithium-ion batteries for industrial applications is increasing. Historically, lead acid batteries have dominated commercial applications for batteries. Industrial applications and uses of OEM batteries include powering material handling equipment such as forklifts, scissor lifts, and robots: powering transportation vehicles (i.e., light electric vehicles such as golf carts, and heavier vehicles, including cars); and diesel generator sets for stationary power applications. Conventional batteries for use in industrial applications assume multiple different form factors and chemistries including, without limitation, lead-acid, nickel metal hydride (“NiMH”), and lithium-ion (LFP, NMC, etc.). The variety of form factors in commercial use today makes the replacement of incumbent problematic.

This wide array of architectures and chemistries has resulted in a wide variety of sizes and shapes of batteries, as well as connecting multiple batteries in series to achieve higher effective voltage. This in turn involved multiple battery assemblies, connectors, connections, and increased bill of materials. Prior approaches modularize batteries in small units, requiring multiple external connectors and connections, which increase the space occupied by the batteries and decrease durability. This has produced applications in which multiple components are connected through external connections, increasing the size, volume, and weight of the battery assemblies as well as requiring constant maintenance. Further, many parts and connections may be exposed to environmental insult and degradation, severely limiting marine use and decreasing the lifecycle of the connections and the battery. Conventional batteries are typically configured for the following voltage classes: 12 V, 24 V, 36 V, 48 V, 72 V, or other voltage specifications. This range of battery configurations requires different batteries having different energies, not met by a common conventional design.

The GC2 form factor is a common battery form factor. There are many different battery voltages in the GC2 form factor, typically 6 V, 8 V, and 12 V, which are connected in series to build up both system voltage (typically to 12 V, 24 V, 36 V, 48 V, 72 V, or higher voltages) and to increase the system stored energy. Lithium-ion technology is a newer battery technology with many advantages over lead acid, such as higher energy density, faster charging, and reduced degradation when stored for long periods.

It would be advantageous to have a lithium-ion “drop-in replacement” to lead acid batteries so that applications can benefit from the advantages of the newer technology without having to reconfigure the space, wiring, battery hold downs, and other existing application features that have already been developed around the GC2 form factor. However, building up voltages with multiple lithium-ion batteries (as is done with lead acid) is expensive due to the addition of series connections for multiple batteries, which are unnecessary due the higher energy density of lithium-ion batteries and added the complexity of series connecting lithium-ion batteries.

There is a need for an improved battery that is, robust, has high energy density and high-capacity utilization, offers a lower total cost of ownership, reduces the overall bill of materials, and is fully integrated within a single module. Providing a battery that is compatible with commercially acceptable form factors while having a higher energy density will increase the energy available to a load and retain the ability to easily replace conventional batteries in applications having one or more form factors. Fully integrated batteries are also more robust, offer longer cycle life, require little or no maintenance due to failures of interconnections between modules, and have fewer components, all of which would decrease the total cost of ownership. Additionally, there is a need for an improved battery that, when suitably configured by modifying only a limited number of parts, is adaptable to differing capacity requirements while retaining the balance of the remaining bill of materials.

There is also a need for improvements over current lithium-ion batteries by integrating monitoring, measurement, and control functions into a single circuit board without requiring a separate housing which is separately wired back into a current collector. In addition, as energy density increases, demands of the safety of the system also increase, thus there exists a need for a battery system that will provide high energy density with improved tolerance to abuse.

There is also a need to improve conventional methods of assembling batteries to produce batteries having higher energy density in a commercially acceptable form factor, more concise design, integrated structure, reduced bill of materials, improved structural integrity, improved resistance to the elements (resilience to water intrusion, spray, dust, etc.), increased reliability, and increased flexibility in manufacturing and use.

Known methods of assembling batteries typically involve substantial bills of materials and multiple assembly and attachment steps. The use of multiple fasteners, connectors, fillers, and structural components results in multiple parts that may be susceptible to fatigue, loosening, damage, or failure from vibration of even normal usage. Improved methods of assembling batteries would eliminate the need for and use of multiple fasteners within the module.

The improved methods of assembly disclosed herein also provide for the use of an integrated battery management system (“BMS”). BMS may be mounted within the case of the battery module, further decreasing the number of components and attachments and minimizing the form factor over conventional methods. Some known methods typically use a separate BMS enclosure that requires attachment to the battery or the application housing, as well as separate electrical and communication wired between the battery and the BMS. These improvements help to make the battery more resistant to water or dust intrusion. See. e.g., ISO Standard IP65 and/or IP67. The improved methods also allow for flexibility to adapt to voltage or power requirements while utilizing the same components within the same form factor.

Disclosed embodiments may include an unconventional battery subassembly, improved components, and methods of battery assembly. As compared to prior known solutions, embodiments of the present disclosure may provide an improved battery that is compatible with commercially acceptable form factors, has certain benefits including one or more of the following: a higher energy density, improved abuse tolerance, robustness to environmental shock and intrusion, reduced cost of ownership, and fully integrated within a single assembly. Other embodiments may include methods of assembling batteries to produce one or more of compatible form factors, more concise designs, better integrated structures, reduced bill of materials, integrated battery management systems, ISO Standard IP65- and/or IP67-compliant products, increased reliability, and increased flexibility in manufacturing and use.

### SUMMARY

Embodiments of the present invention include improved energy densities and flexibility. This flexibility can be provided in two ways. First, multiple batteries can be stacked (electrically connected in parallel) to build capacity to meet energy requirements of the application. Second, embodiments of the present disclosure feature a high degree of commonality of component parts, namely, some or all the same components can be used in the same form factor (e.g., GC2) to make a variety of batteries that differ in voltage and/or capacity. Embodiments of the present invention can achieve this degree of flexibility by changing only a few or preferably one component part. Further, this flexibility can be achieved to change the energy of the battery without changing any component parts, by increasing or reducing the number of cells included in the battery. This architecture provides substantial flexibility to a manufacturer or user.

In embodiments of the present disclosure, cells can be connected into subassemblies, and subassemblies can be electrically connected in the desired configuration to meet desired capacity and/or voltage requirements. In embodiments of the present disclosure, flexibility can mean having a common bill of materials with changes to the number of cells, current collector design, and/or BMS.

This present disclosure enables cost-effective production of lithium-ion batteries with any desired form factor, at different system level voltages and capacities. This is achieved by sharing most internal parts between the different battery voltages folding/wrapping the current collector to reduce fasteners and manufacturing cost, adding foam which enables closer packing of cells and assists with mechanically securing cells, without fasteners and/or other additional structural components.

In the present disclosure, cells can be connected: in parallel to build capacity at the voltage of an individual cells; or in series to build voltage at the capacity of the individual cells. Cells can be electrically connected in series to form a group and groups of cells electrically connected in parallel to form a subassembly. Alternatively, in a preferred embodiment, cells are electrically connected in parallel to form a group and groups of cells electrically connected in series to form a subassembly. In a preferred embodiment, two subassemblies are electrically connected using a configurable, flexible current collector to accommodate the preferred form factor of the system. The first subassembly comprises a lower cell carrier and upper cell carrier between which the first groups of cells are disposed. The second subassembly comprises the lower cell carrier and upper cell carrier between which a second group of cells are disposed. The flexible current collector comprises two or more conductive regions. The first and second subassemblies are connected in parallel or series to build the desired voltage or capacity of the battery. The flexible current collector can be folded, and the assembly disposed within casing to provide environmental protection to the battery. Positive and negative terminals can be connected to first and second conductive regions, respectively, to form positive and negative terminals of the battery.

The present disclosure achieves higher energy density through one or more of multiple features. The lower and upper cell carriers are configured to affix the cells in position to resist displacement and dispose the cells in close proximity to one another. The disposition of foam in the gaps between cells enhances safety and robustness to vibration, shock, mechanical displacement, and environmental insult. This combination of features allows embodiments of the present disclosure to achieve higher energy density. Further, integration of the positive and negative terminals into the BMS and flexible current collector, and press fitting of components reduces the number of electrical connections required, and thereby facilitates efficient manufacturing and effective electrical connection.

A battery comprising cells can be electrically connected to form a group: groups of cells can be electrically connected to form first and second subassemblies; first subassembly can include lower tray and upper tray between which first groups of cells are disposed, and can have first and second faces: second subassembly can comprise lower tray and upper tray between which second groups of cells are disposed, and can have first and second faces: a flexible current collector can comprise two or more conductive regions; first and second subassemblies can be electrically connected to build voltage or capacity of the battery: the flexible current collector can be electrically connect first and second subassemblies and disposed within casing to provide environmental protection to battery: positive and negative terminals can be electrically connected to first and second conductive regions, respectively to form positive and negative terminals of battery: and a battery management system can be electrically connected to the flexible current collector and positive and negative terminals adapted to control the flow of energy through the battery.

A method of assembling a battery can comprise, inserting cells into inner and outer trays of first and second carriers to form two subassemblies: placing current collector: electrically connecting cells to current collector; and folding the current collector and subassemblies.

### BRIEF DESCRIPTION OF THE DRAWINGS

The accompanying drawings, which are incorporated in and constitute a part of this specification, illustrate several embodiments and, together with the description, explain the disclosed principles. In the drawings:

FIG. 1 is an exploded schematic view of the battery, according to an embodiment of the present disclosure.

FIGS. 2A-C are schematics of a lid, according to an embodiment of the present disclosure.

FIGS. 3A-C are schematics of two partially-assembled subassemblies, according to an embodiment of the present disclosure.

FIG. 4 is a schematic of two partially-assembled subassemblies with cells placed within the apertures, according to an embodiment of the present disclosure.

FIGS. 5A-B are schematics of two subassemblies, according to an embodiment of the present disclosure.

FIG. 6 is a schematic of a partially assembled assembly with the flexible current collector installed, according to an embodiment of the present disclosure.

FIG. 7 is a schematic of a partially assembled assembly, according to an embodiment of the present disclosure.

FIGS. 8A-B are schematic cross-sections of current collector, according to alternative embodiments of the present disclosure.

FIG. 9A-B are schematics of an assembly, according to an embodiment of the present disclosure.

FIG. 10A is a cross-section of an assembly, according to an embodiment of the present disclosure.

FIG. 10B is a cross-section of an assembly, according to an embodiment of the present disclosure.

FIG. 11A-E are illustrations of assembling a battery, according to an embodiment of the present disclosure.

FIG. 12 is flowchart for a method for assembling a battery, according to an embodiment of the present disclosure.

FIG. 13 illustrates a current collector for a 24 V battery, according to an embodiment of the present disclosure.

FIG. 14 illustrates an example current collector for a 48 V battery, according to an embodiment of the present disclosure.

FIG. 15 illustrates an exploded view of two subassemblies, a flexible current collector, and a heat sink, according to an embodiment of the present disclosure.

FIG. 16A illustrates a 48 V battery using a cell carrier, according to a preferred embodiment of the present disclosure.

FIG. 16B illustrates an alternate 48 V battery using the cell carrier of FIG. 16A, according to an embodiment of the present disclosure in which certain of the cell positions in the carriers are unoccupied, providing lower energy than the embodiment depicted in FIG. 16A.

### DESCRIPTION OF THE EMBODIMENTS

Embodiment consistent with the present disclosure can include a battery, components thereof, and an improved method of assembly. Cells are preferably connected in parallel to form a group of cells. Groups of cells are preferably connected in series to form a subassembly. A subassembly can comprise one-half of a battery's cells. Two or more subassemblies can be connected by a flexible current collector in embodiments of the present disclosure to form a battery. A battery can include multiple cells assembled in a housing to protect the cells from external shock, vibration, and environment. Battery cells can be cylindrical or prismatic. A battery can provide a nominal voltage of 12 V, 24 V, 36 V, 48 V, 72 V or any other suitable voltage according to device or product specifications. Additionally, or alternatively, a battery can be configured to provide a non-standard nominal voltage, according to specific device or product specifications. Preferred embodiments are configured to 24 V, 36 V, and 48 V classes.

Embodiments of the present invention improve energy density and provide greater manufacturing flexibility relative to prior known batteries. Embodiments of the present disclosure feature a high degree of commonality of component parts. Namely, some or all the same components can be used in the same form factor to make a variety of batteries that differ in voltage and/or capacity, by changing only a few or preferably no component parts, for example, by increasing or reducing the number of cells included in the battery. This improved architecture provides substantial flexibility to a manufacturer or user.

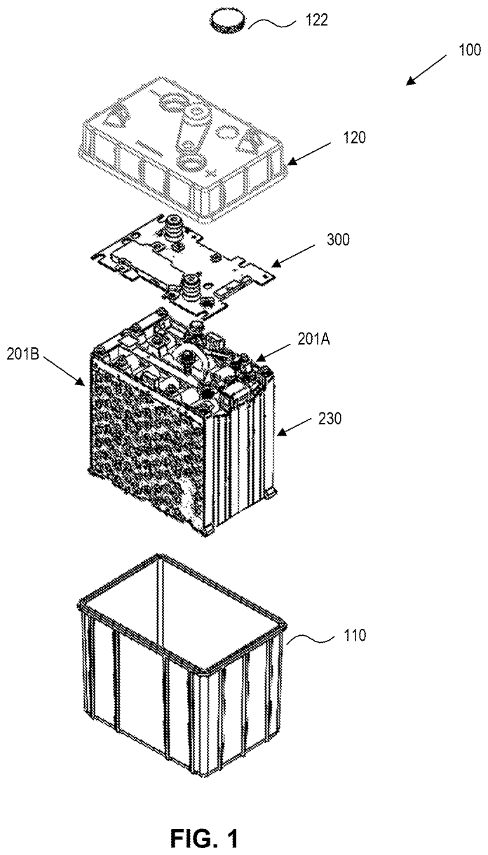

FIG. 1 depicts battery 100, which can include case 110, lid 120, an assembly 200 comprising first and second subassemblies 201A, 201B and current collector 230, and battery management system (BMS) 300.

In an example, case 110 can be dimensioned to receive assembly 200 and/or to standard or pre-determined dimensions. Case 110 can comprise one or more of: electrically insulating material, thermally insulating material, or fire-retardant material. In another example, case 110 can be patterned, textured, coated, or ribbed. Case 110 can receive lid 120, thereby creating a seal between lid 120 and case 110.

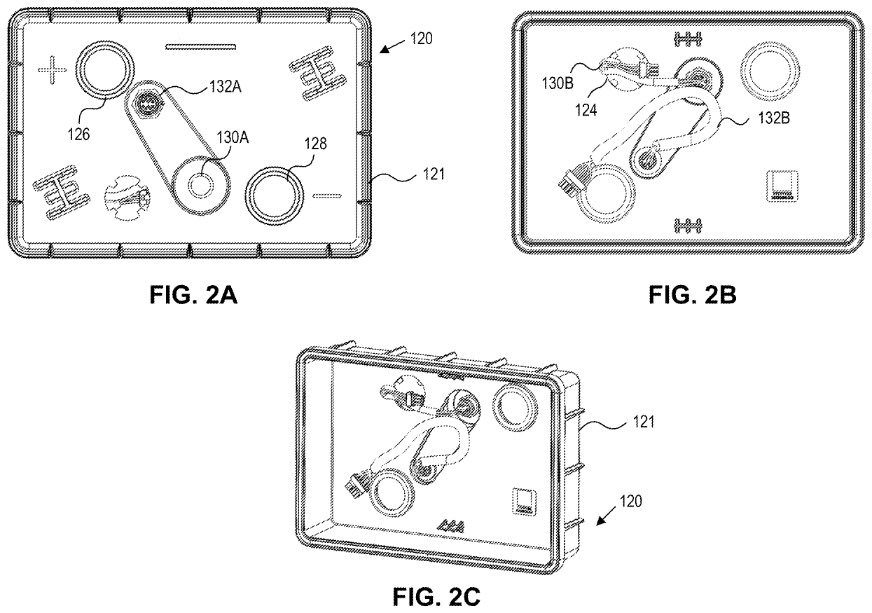

FIGS. 2A-C are schematics of lid 120 can be dimensioned to receive assembly 200. Lid 120 can include one or more of: electrically insulating material, thermally insulating material, or fire-retardant material. In another example, lid 120 can be patterned, textured, coated, or ribbed. Lid 120 can include vent 122 (as shown previously in FIG. 1) configured to vent excess gas. Lid 120 can include lip 121, vent 122, and/or vent aperture 124. Additionally, lid 120 can include first terminal aperture 126, second terminal aperture 128, indicator 130A, indicator wiring harness 130B, electrical interface 132A, and/or electrical interface wiring harness 132B.

Indicator 130A can include a display, LED light, color changing strip, or speaker to communicate battery status to a user when the CAN bus of battery 100 is not utilized. For example, BMS 300 can alter color or brightness of the indicator to indicate a battery state. In an example, when the battery charge is low, BMS 300 can change the indicator color from green to red. In another example, when the battery is charging, BMS 300 can change the brightness of the indicator to produce a visible “blink” or “pulse”. In additional, alternative embodiments, an audible signal can be provided in addition to, or in lieu of a visual signal.

Additionally, or alternatively, when a CAN bus interface of the BMS 300 is utilized, the BMS can send and/or receive data using one or more processors to communicate with one or more batteries connected to the CAN bus interface. The data may include self-identifying information (e.g., model, serial number, error codes), information indicating battery status, and/or information indicating battery configurations (e.g., series configuration and/or parallel configurations).

Indicator wiring harness 130B can be in electrical communication with BMS 300 and indicator 130A and configured to transport data and/or electrical signals between one another.

Electrical interface 132A can be a receptacle to facilitate data communications between the BMS 300 and external computing devices, such as, computers, mobile devices, or battery chargers, battery charging stations, on-boards computers of various vehicles, or other battery management systems. Electrical interface wiring harness 132B can be in electrical communication with BMS 300 and electrical interface 132A and configured to transport data and/or electrical signals between one another.

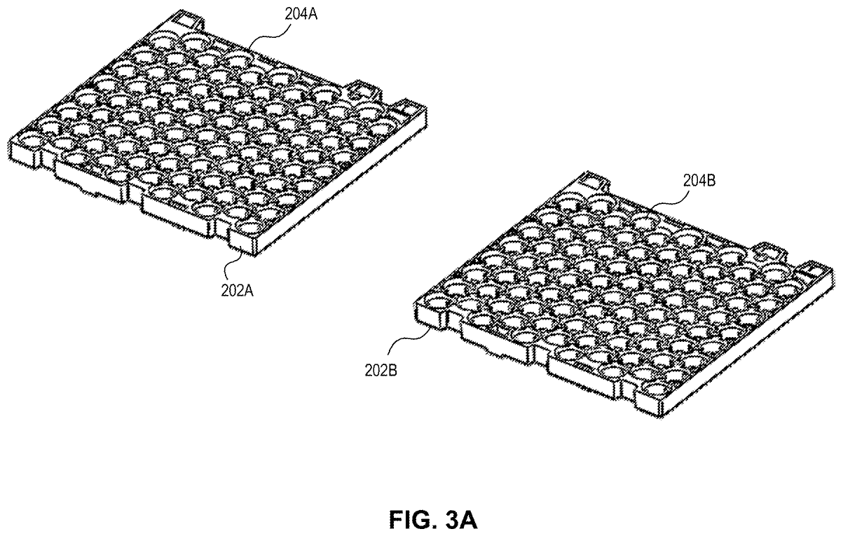

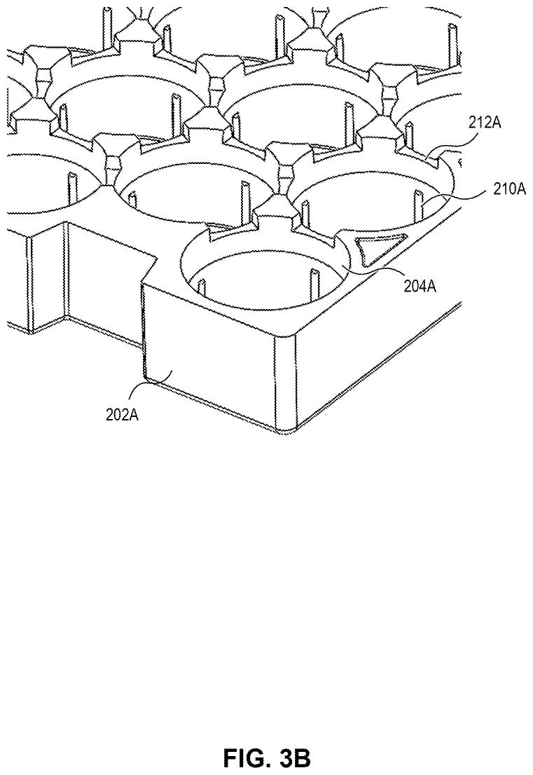

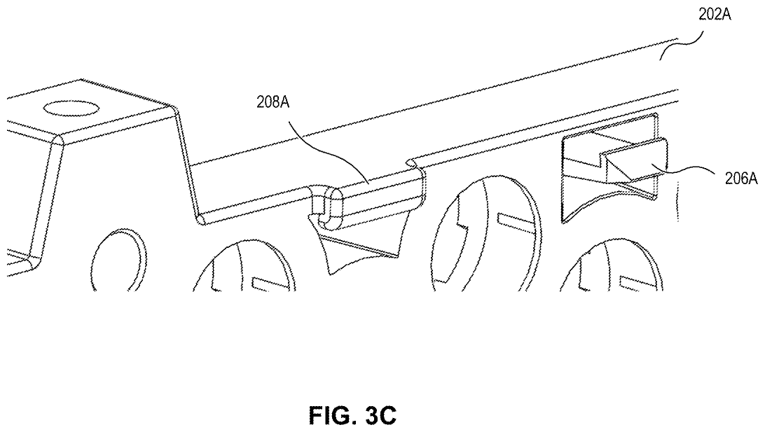

FIGS. 3A-C are schematics of two partially-assembled subassemblies. FIG. 3A depicts first inner cell carrier (e.g., first bottom cell carrier) 202A can include a plurality of apertures 204A. Second inner cell carrier (e.g., second bottom cell carrier) 202B can include a plurality of apertures 204B. First and second inner cell carrier 202A, 202B can include one or more of: electrically insulating material, thermally insulating material, or fire-retardant material.

FIG. 3B depicts a detail view of first inner cell carrier 202A. Each of the plurality of apertures 204A of the first inner cell carrier 202A can include a plurality of ribs 210A and a plurality of windows 212A. The plurality of ribs 210A can be integral and crushed upon receiving a cell, thereby providing an interference fit. Though only first inner cell carrier 202A is shown, it will be understood that similar features can be included in second inner cell carrier 202B.

FIG. 3C depicts a detail view of a retaining feature. First inner cell carrier 202A can include first retainment mechanism 206A located on first inner cell carrier 204 and second retainment mechanism 208A located on first inner cell carrier 202A. First retainment mechanism 206A can be configured to interlock with second retainment mechanism of second inner cell carrier 202B. Retaining mechanisms can include at least one of: clips, hooks, hook and loop fasteners, suction cups, sticky pads, anchors, dowels, pins, retaining rings, snap fasteners, latches, or other fasteners. Though only first inner cell carrier 202A is shown, it will be understood that similar features having similar functions can be included in second inner cell carrier 202B. This retention feature can serve to retain the two subassemblies 201A and 201B in a physically parallel configuration.

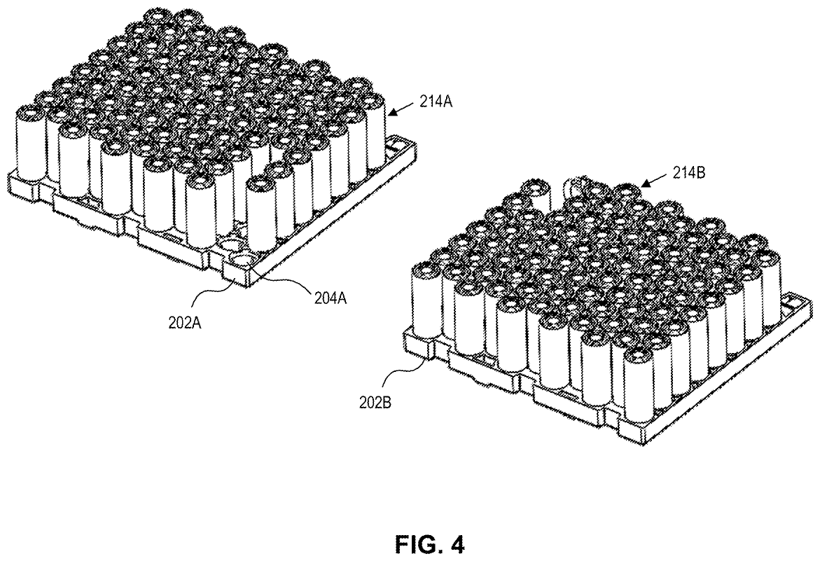

FIG. 4 depicts two partially-assembled subassemblies with cells placed within the apertures. Each cell of a first set of cells 214A, can be placed in an aperture of the plurality of apertures 204A. Each cell can be retained within the aperture though an interference fit between the aperture and the cell. The interference fit can result from crushing one or more ribs 210A. Each cell in the first group of cells 214A can comprise positive terminal and negative terminal.

Each cell of a second set of cells 214B, can be placed in an aperture of the plurality of apertures 204B. Each cell can be retained within the aperture though an interference fit between the aperture and the cell. The interference fit can result from crushing one or more ribs if second inner cell carrier 202B. Each cell in the second group of cells 214B can comprise positive terminal and negative terminal.

In embodiments of the present disclosure comprising cylindrical cells, the entire outer surface apart from a small portion isolated electrically from the positive terminal can comprise the negative terminal.

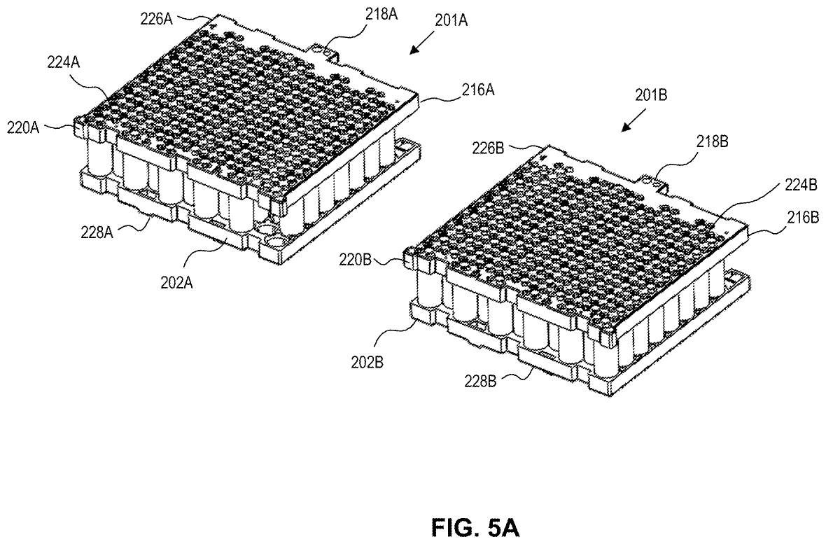

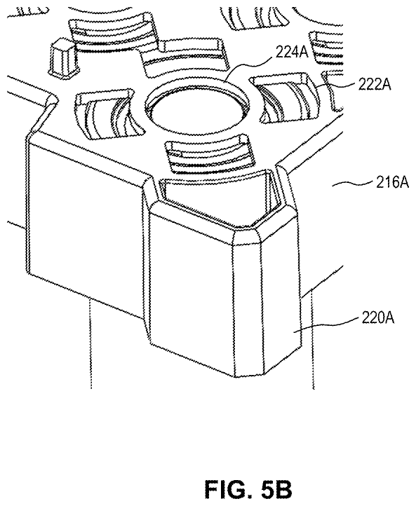

FIG. 5A depicts two subassemblies with first and second outer cell carriers 218A, 218B. First subassembly 201A can include first inner cell carrier (e.g., first bottom cell carrier) 202A, first group of cells 214A, and first plurality of apertures for receiving cells 204A. Additionally, first subassembly 201A can include first outer cell carrier 216A (e.g., first top cell carrier), which can include a plurality of apertures 224A adapted to receive first set of cells 214A, first lift point 218A, and a plurality of spacers 220A. First lift or contact point 218A may be utilized at a later stage of assembly to dispose the completed assembly in or out of case 110. Additionally, the first lift or contact point 218A can be vibration-welded to lid 120. Additionally, the plurality of spacers 220A may be utilized to position first subassembly 201A within case 110 and maintain a distance between the case 110 and the first outer cell carrier 216A. First outer cell carrier 216A can include one or more of: electrically insulating material, thermally insulating material, or fire-retardant material. First subassembly 201A can include a first face 226A, configured to have disposed thereon, current collector 230; and a second face 228A configured to interlock with second subassembly 201B.

Second subassembly 201B can include second inner cell carrier (e.g., second bottom cell carrier) 202B, second group of cells 214B, and first plurality of apertures for receiving cells 204B. Additionally, second subassembly 201B can include second outer cell carrier 216B (e.g., second top cell carrier), which can include a plurality of apertures 224B adapted to receive second set of cells 214B, second lift point 218B, and a plurality of spacers 220B. second lift or contact point 218B may be utilized at a later stage of assembly to dispose the completed assembly in or out of case 110. Additionally, the second lift or contact point 218B can be vibration-welded to lid 120. Additionally, the plurality of spacers 220B may be utilized to position second subassembly 201B within case 110 and maintain a distance between the case 110 and the second outer cell carrier 216B. Second subassembly 201B can include a first face 226B, configured to have disposed thereon, current collector 230; and a second face 228B configured to interlock with first subassembly 201A.

FIG. 5B depicts first outer cell carrier 216A comprising cutouts 222A around aperture 224A in which cells 214A are disposed. This feature provides enhanced flexibility in assembling batteries of varying voltage, current, and energy from common components. The cutouts in upper cell carrier provide flexibility in disposing a flexible current collector 230 to facilitate different architectures based on common components, while modifying only the pattern of conductors in flexible current collector. Though only first outer cell carrier 216A is shown, it will be understood that similar features having similar functions can be included in second outer cell carrier 216B.

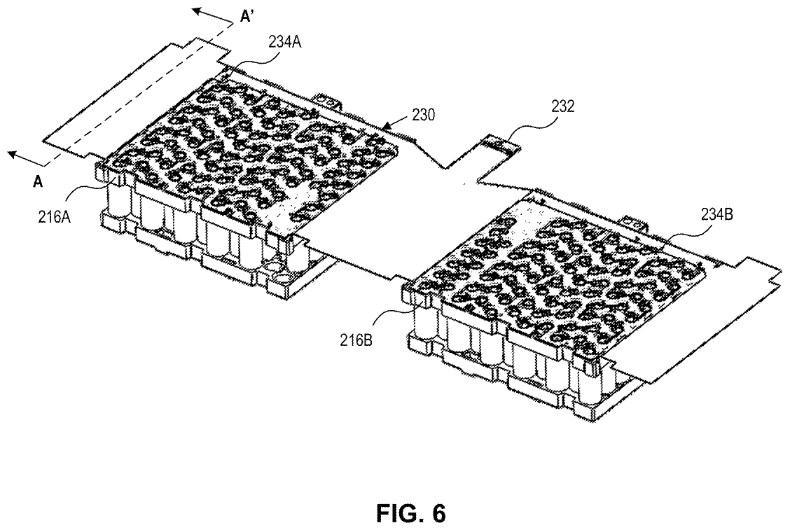

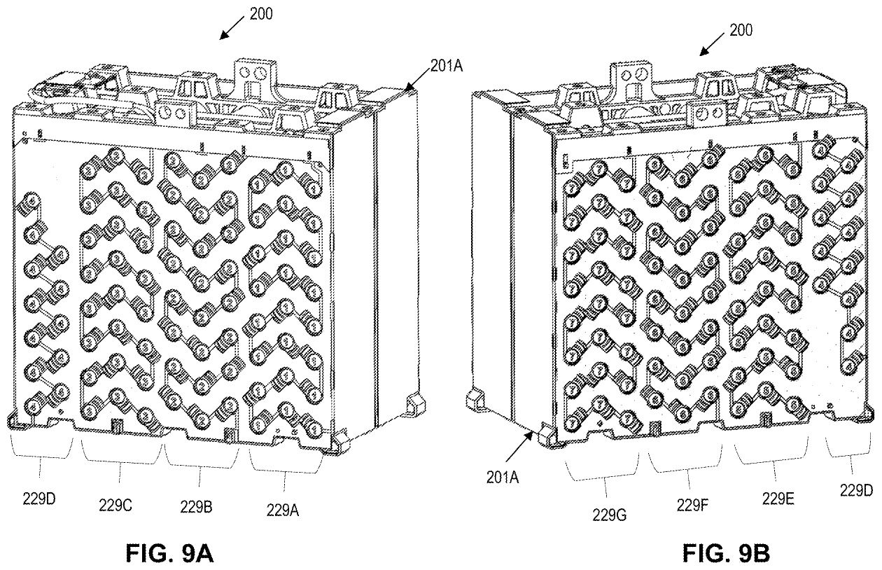

FIG. 6 depicts a partially assembled assembly with the flexible current collector installed. Flexible current collector 230 can be single plate which includes plurality of conductive regions. With reference to FIGS. 9A and 9B, the plurality of conductive regions 229a-229g are depicted. Turning back to FIG. 6, additionally, or alternatively, each conductive region can include integrated fuses 234A and 234B, thereby removing the need for fuses within wiring harnesses 232 found in conventional batteries.

In examples, flexible current collector 230 can include a layered, flexible current collector 230. Layers within flexible current collector 230 can provide voltage sensing, fusible elements, fiducial points, and conduct electricity. For example, one layer can be a copper conductive layer while other layers are non-conductive. This can allow each cell to be connected to the conductive layer in series and/or parallel groupings.

In examples, flexible current collector 230 can be bendable (e.g., foldable) without breaking or sustaining damage. Flexible current collector 230 can reduce the number of joints within a module, leading to lower resistance and greater ease of manufacturing. flexible current collector 230 can be bendable around a center point, line, or other axis comparable to a hinge. Flexible current collector 230 can include one or more bends such that flexible current collector 300 has substantially “U” profile in bent configuration.

In examples, flexible current collector 230 can include stamped or printed fusible links. Flexible current collector 230 can comprise different suitable materials and coatings. Flexible current collector 230 can be mechanically and electrically connected to battery cells to form subgroups of battery cells connected in series and/or parallel. Subgroups of cells can be connected by flexible current collector 230 in series and/or parallel with other subgroups of cells.

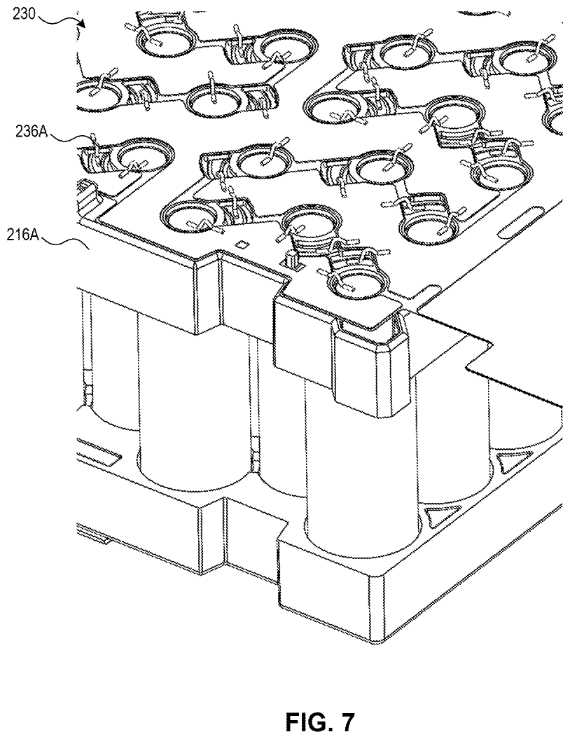

FIG. 7 depicts a detail of a partially assembled assembly with fusible links. In examples, flexible current collector 230 can be connected to cells by wire bonding, laser welding, adhesive, or other appropriate electrically conductive connection.

Fusible link 236A can carry current from cells to current collector. Fusible link 236A can serve as a fuse to sever the connection between an individual cell and current collector at an appropriate current flow level. This may enhance safety by preventing combustion or a thermal event. Specifically, fusible link may melt and disconnect cell from current collector and, thus, remaining cells. This design can be tailored for the desired voltage and/or current. The precise parameters of the fusible link 236A can be controlled by varying the shape, thickness, width, and/or material composition of the fusible link 236A.

Fusible link 236A may be integrally formed within current collector. The structure of fusible link 236A may be varied to meet a variety of functional, performance, or safety requirements according to individual product design and use.

Fusible link 236A can comprise wire bond, laser welded connection, or ribbon bonds to join current collector to cells as a fuse. Multiple alternative shapes and fusible link designs may perform the same function. Persons of skill in the art would understand that the shape of the fusible link may depend on individual specifications, such as variances among cells, fusing characteristics, materials, cell types, process of manufacture, and intended use. In certain embodiments, fusible link can be a laser-wielded, stamped fusible link.

Fusible links may increase the safety of the battery overall. Fusible links may provide fuse functionality to the current collector, without the need for specialized processes or additional parts, which may introduce the potential for substantial variances and errors. Fusible links may be connected to the terminals of battery cells using either resistance or laser welding, wire bonding, adhesive, or other electrically conductive connection.

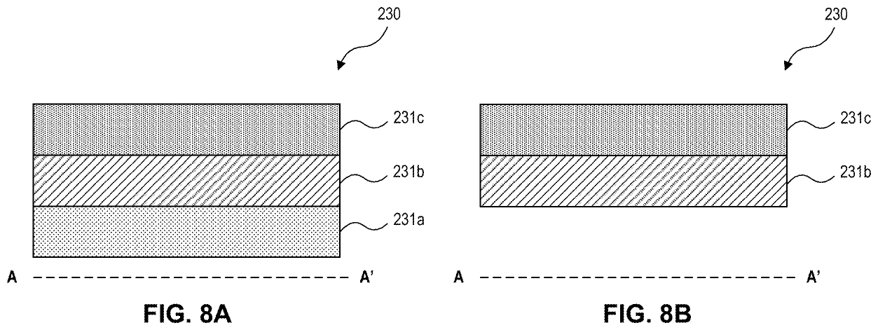

FIGS. 8A, and 8B depicts flexible current collector 230, which can comprise one or more layers 231a, 231b, and/or 231c. In an example, flexible current collector 230 can include first layer 231a, which can include a pressure sensitive adhesive configured to bond to first faces 226A, 226B of the first and second subassemblies 201A, 201B. Second layer 231b can include a conductor, for example, copper or aluminum. Second layer 231b can include aluminum, copper, or other conductive metal and can be configured to receive one or more wire bond(s) or other suitable connections from one or more of: first group of cells 214A or second group of cells 214B. Third layer 231c can comprise a plastic layer for example, PET.

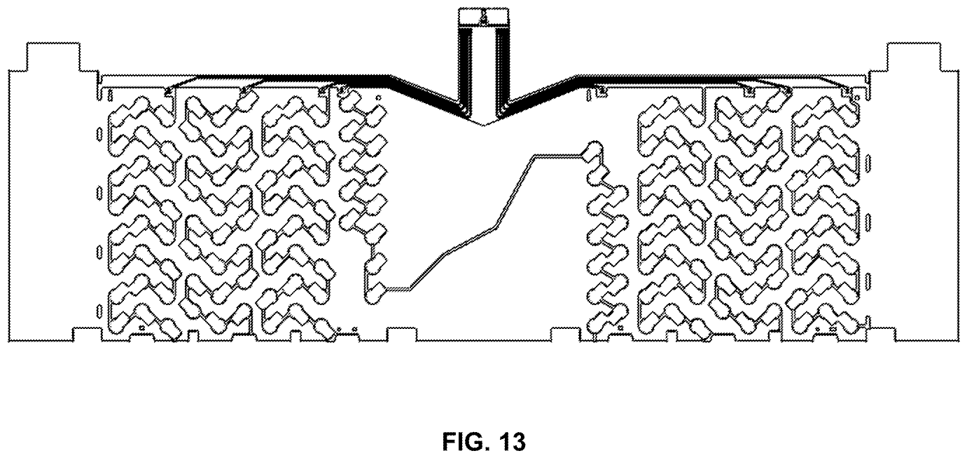

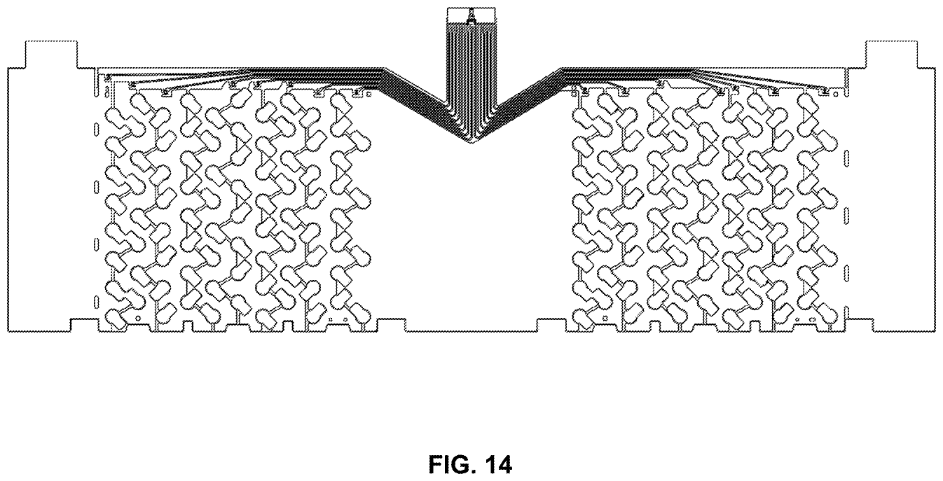

In an embodiment, flexible current collector is designed to carry a 400 A current (preferably 450 A) for 30 secs., and to carry 120 A (preferably 150 A) continuous current. The copper thickness to carry these current loads is preferably 0.20 to 0.25 mm thick. Holes can be added at bending corners to assist with bending and buckling of current collector. Wire bonds are preferably not placed near the fold. FIGS. 13 and 14 depict two alternative current collectors. The negative cut out in the conductor is preferably disposed to align with the separation between conductors to preserve conductive material.

In an alternative embodiment, as shown in FIG. 8B, flexible current collector 230 need not include first layer 231a and can be attached using mechanical fasteners to subassemblies 201A, 201B. Additionally, flexible current collector 230 offers substantial flexibility, and can be adapted to carry current in multiple alternative configurations. Preferably, sufficient current collector cross-section is maintained to not add heat or impair current transport.

In alternative embodiments of the present disclosure adapted for higher voltage applications, fourth layer can be added and include a further conductive layer and can be deposited on third layer 231c. Fourth layer can comprise aluminum, copper, or other conductive metal and can be configured to receive one or more wire bond(s) or other suitable connections from one or more of: first group of cells 214A or second group of cells 214B. Fourth layer can include plurality of conductive regions, for example, plurality of conductive regions.

FIGS. 9A, and 9B depict a folded assembly from a first and second angle with the current collector 230 having a plurality of conductive regions 229A-229G. The numbers 1-7 one each cell, and shown for illustrative purposes, depict cell subgroups Each conductive region 229A-229G can be electrically connected to various battery components through connection 232.

In certain embodiments, conductive region 229D may “wrap around” to the other side of the assembly 200. Flexible current collector 230 can be configured so that battery cells are connected in series and/or parallel.

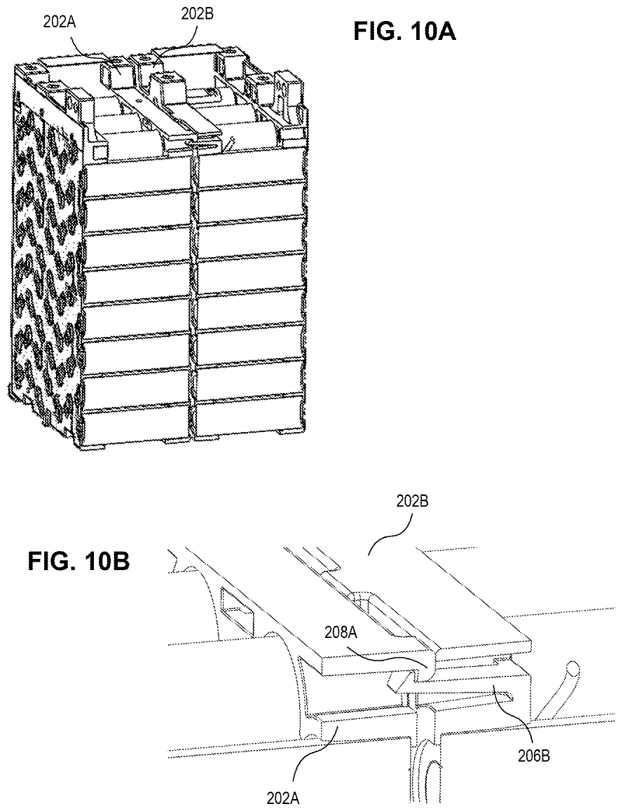

FIG. 10A is an oblique schematic view of a partially disassembled embodiment of the present disclosure depicting an air gap disposed between the two subassemblies and a flexible current collector of an embodiment of the present disclosure. In certain embodiments of the present disclosure, a cold plate or heat sink material can be disposed between the first and second inner cell carriers 202A, 202B to transfer heat away from the modules. Cold plate is electrically isolated from the negative terminals of the cells. Embodiments of the present disclosure can comprise a heat transfer material disposed in this air gap between the bottom of the cells and the cold plate to facilitate heat transfer while maintaining electrical isolation.

In certain embodiments, heat sink or cold plate can be disposed between the subassemblies in their folded orientation. Cold plate or heat sink can be actively cooled, for example, a water-cooled or fan-cooled heatsink. Additionally, or alternatively, the cold plate or heat sink can be passively cooled such that the cold plate or heat sink can be configured to release heat substantially by natural convection. Alternatively, battery 100 can utilize an air gap between first and second subassembly 201A and 201B and need not include a cold plate or heat sink disposed between two subassemblies connected by a folded flexible current collector 230.

FIG. 10B is an oblique schematic detail of a retaining feature. As discussed above, second retention mechanism 208A of first inner cell carrier 202A may interlock with first retention mechanism 206B of second inner cell carrier 202B. This retention feature can serve to retain the two subassemblies 201A and 201B in a physically parallel configuration.

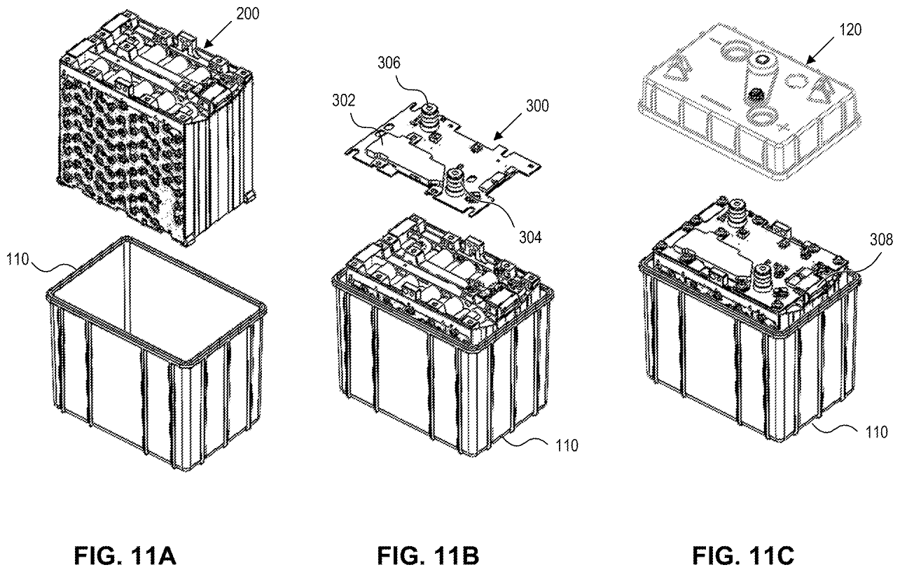

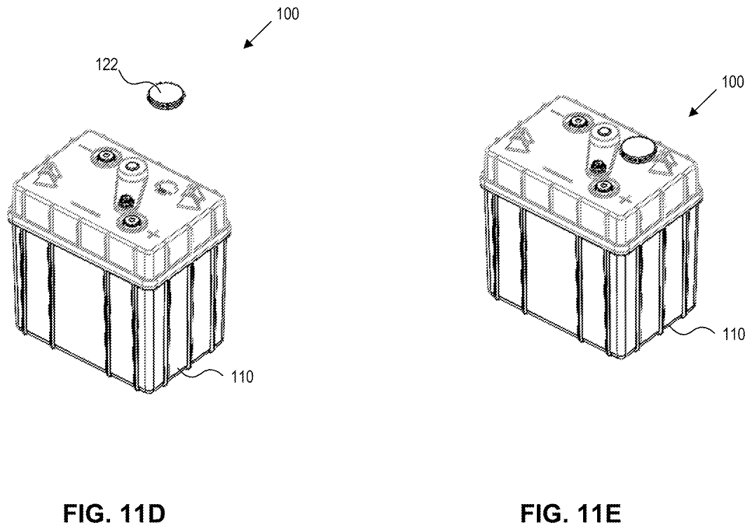

FIG. 11A-E are illustrations of assembling a battery of a preferred embodiment of the present disclosure. FIG. 11A illustrates placing the assembly 200 within case 110.

FIG. 11B depicts attachment of the BMS 300 onto the assembly 200. The BMS 300 can include a heatsink 302, a first integral terminal 304, and a second integral terminal 306. The BMS 300 can be electrically connected to the assembly 200. The BMS may include one or more processors, memory with instructions thereon, which, when executed, can cause the BMS 300 to perform one or more functions. The one or more function can include managing electrical and/or thermal loads, detecting errors, or sending and/or receiving data to/from external computing devices.

FIG. 11C depicts harness 232 of current collector 230 connecting with BMS receptacle 308. Additionally, lid 120 can be placed over BMS 300 and in physical connection with case 110. Additionally, BMS 300 maybe electrically connected to wiring harnesses of lid 120.

FIG. 11D depicts installation of vent 122 into vent hole 124. Prior to installation of vent 122, a number of quality and/or safety checks may be performed. For example, an electrical check may be performed to verify the integrity of various electrical connections. Lid 120 can be vibration welded to the case 120. A leak check can be performed to verify the physical integrity of the battery 100. Foam, liquid, or gel may be injected through the vent hole 124 into the case 110 and disposed around cells to fill the space between cells, and between cells and an interior surface of casing. This foam, liquid, or gel can provide insulation and can prevent propagation of thermal events between individual cells. Foam, liquid, or gel can also provide structural support by resisting vibration and aiding in mechanical retention of battery cells and components. Foam, liquid, or gel can provide thermal insulation, deflect and channel venting gasses, and adsorb radiant heat.

FIG. 11E depicts battery 100.

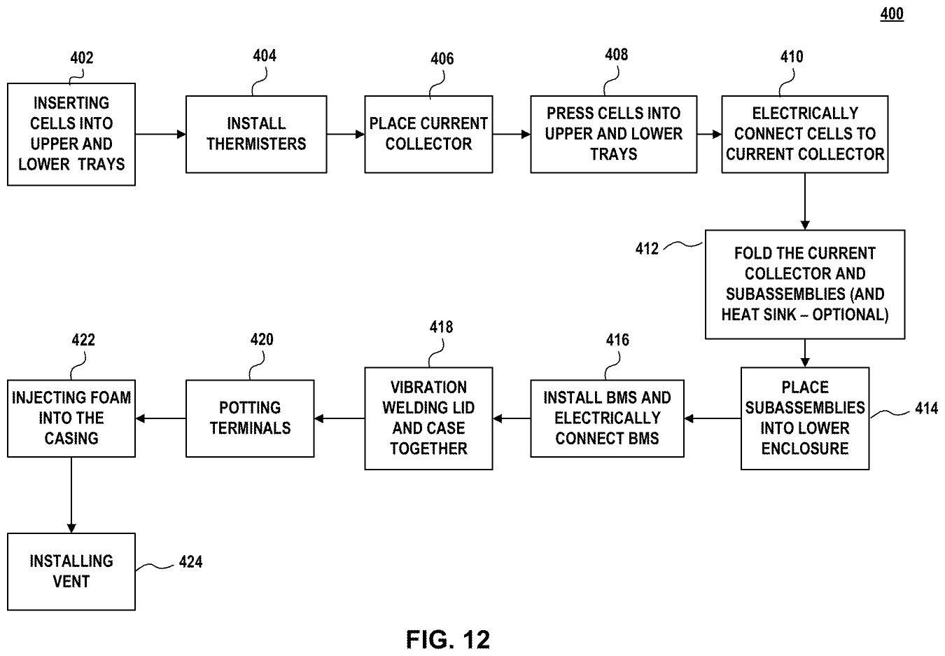

FIG. 12 depicts a method of manufacturing battery 100. The basic steps of an exemplary method are depicted in FIG. 12. It is to be understood that steps comprising method can be varied, combined, omitted, reordered, or otherwise altered according to the target specifications of the battery.

At block 402, method 400 can comprise inserting cells into cell carriers. Inner and outer cell carriers are preferably adapted to accept cells by interference fit, either with or without an insert to facilitate fitting cells into cell carriers. In embodiments, insert can be placed into recess of inner cell carrier, thereby electrically isolating each cell from cold plate, while disposing the cell in sufficient proximity to cold plate to facilitate effective heat transfer. Alternatively, in a preferred embodiment, the part can be provided by a manufacturer with the threaded inserts installed.

At block 404, method 400 can include installing thermistors, proximate one or more cells.

At block 406, method 400 can comprise connecting placed cells to flexible current collector. Additionally, or alternatively, cells can be first group of cells, and method 400 can further comprise connecting placed second group of cells to flexible current collector. Additionally, or alternatively, cells can be first group of cells, outer cell carrier can be first outer cell carrier, and method 400 can further include bonding flexible current collector to second outer cell carrier. Additionally, or alternatively, bonding flexible current collector to second outer cell carrier can further comprise folding the flexible current collector such that first and second inner cell carrier are substantially parallel in physical orientation to one another, engaging retaining feature to retain configuration of first and second inner cell carrier, and wire bonding first terminal to first conductive region of the flexible current collector. Additionally, or alternatively, bonding flexible current collector to second outer cell carrier can further comprise wire bonding first terminal to first conductive region of flexible current collector, folding flexible current collector such that first and second inner cell carrier are proximate to one another, and engaging retaining feature to retain configuration of first and second inner cell carrier.

At block 408, method 400 can comprise pressing subassembly assembly. The method 400 can comprise placing cells into inner cell carrier (e.g., bottom cell carrier). Cells can be lithium-ion cells. Additionally, or alternatively, cells can comprise first group of cells, inner cell carrier can comprise first inner cell carrier, and method can further comprise placing second group of cells into second inner cell carrier. In an example, cells can include first terminal and second terminal. Terminal can be a terminal of a cell, for example, first terminal can be positive terminal of a cell and second terminal can be negative terminal of a cell. Placement of each cell in the first and/or second inner cell carrier can be done using robots or other automated mechanisms. In an example, the direction of the cells (e.g., the orientation of first and/or second terminals) can be oriented away from another cell. In another example, the orientation of the cells can be such that tabs are proximate the housing. The method 400 can comprise placing outer cell carrier (e.g., top cell carrier) atop placed cells, outer cell carrier including a plurality of recesses configured to receive each cell. Additionally, or alternatively, cells can be first group of cells, outer cell carrier can be first outer cell carrier, and method 400 can further comprise placing a second outer cell carrier atop placed second group of cells, second outer cell carrier including plurality of recesses configured to receive each of second group of cells.

At block 408, method 400 can comprise electrically connect cells to current collector.

At block 412, method 400 can comprise folding current collector and subassemblies (and heat sink, if utilized).

At block 416, method 400 can comprise installing battery management system and electrically connecting battery management system to current collector.

At block 418, method 400 can comprise vibration-welding lid and case together. In an example, lid can be connected to housing using vibration-welding. Vibration-welding can fuse lid material to housing material, thereby making lid and housing integral. Additionally, lid can be vibration-welded to subassemblies at lift points (e.g., first and second lift points 211, 221). The vibration-welding process can fuse lift points to lid, thereby making the assembly integral with lid.

At block 420, method 400 can comprise potting one or more terminals with epoxy.

At block 422, method 400 can comprise injecting foam into housing. In an example, foam, liquid, or gel can be disposed around cells within casing to fill space between cells and between cells and interior surface of casing. This foam, liquid, or gel can provide insulation and can prevent propagation of thermal events between individual cells. Foam, liquid, or gel can also provide structural support by resisting vibration and aiding in mechanical retention of battery cells and components. Foam, liquid, or gel can provide thermal insulation, deflect and channel venting gasses, and adsorb radiant heat.

At block 424, method 400 can comprise installing vent (e.g., vent 105) to lid. Vent can comprise a pressure sensitive permeable membrane, which can be configured to rupture over a predetermined pressure threshold. For example, the pressure sensitive membrane can be configured to rupture at 25 psi (e.g., 25 psi above the surrounding air pressure). Upon internal air pressure within the battery reaching greater than or equal to 25 psi above surrounding air pressure, pressure sensitive membrane can rupture, allowing internal pressure of battery to vent and reach equilibrium with air pressure of the environment or surroundings. The permeable membrane also allows pressure equalization between battery an environment, for example during transportation by aircraft.

FIG. 13 illustrates an example current collector for a 24 V battery, according to an embodiment of the present disclosure.

FIG. 14 illustrates an example current collector for a 48 V battery, according to an embodiment of the present disclosure.

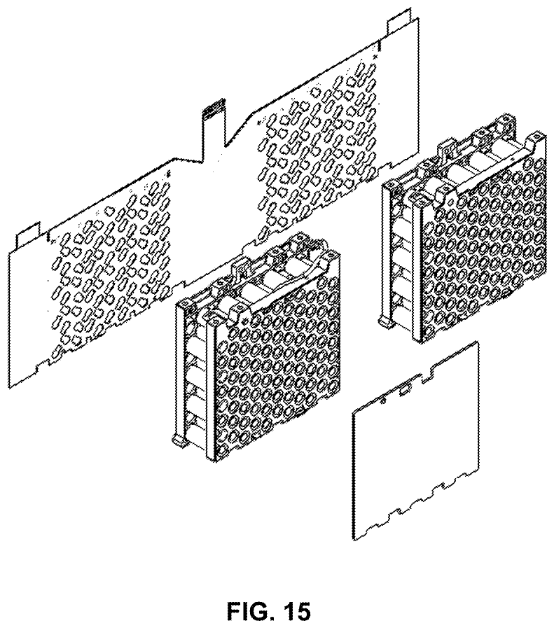

FIG. 15 illustrates an exploded view of two subassemblies, a flexible current collector, and a heat sink, according to an embodiment of the present disclosure.

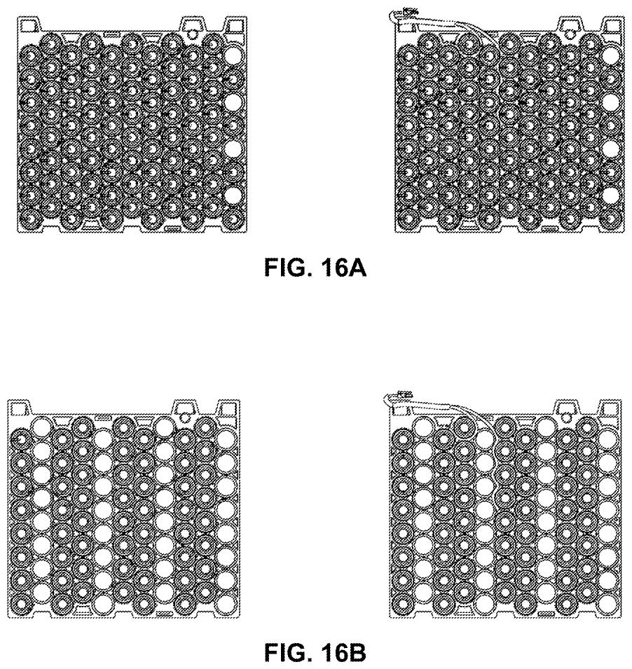

FIG. 16A illustrates a 48 V battery using a cell carrier, according to a preferred embodiment of the present disclosure.

FIG. 16B illustrates an alternate 48 V battery using the cell carrier of FIG. 16A, according to a preferred embodiment of the present disclosure, in which multiple of the spaces for cells in carrier are left unoccupied, providing lower capacity or energy, without changing any other components of battery or the process of manufacturing battery.

### Example 1

Twenty-four cells were electrically connected in parallel to form a group, and 3.5 groups of 24 cells each were electrically connected in series to form a subassembly. Two such subassemblies were prepared and electrically connected by the flexible current collector. The wrap around portion of the current collector connects the two 3.5 groups in parallel. The two subassemblies were folded toward one another with the current collector in the outside, and if used, a heat sink positioned between the inside faces of the two subassemblies. If an electrically conductive heat sink is used, an electrically insulating, thermally conductive interface material is placed on the exposed surfaces of the cells on the two open faces of the subassemblies. The two subassemblies are then brought together, closed, and latched, capturing the heat sink in a predetermined position between the two subassemblies.

This assembly is then placed in the lower portion of the case, the BMS was then attached and electrically connected to the electrical connection points on the assembly and on lid. An electrical check was performed to determine the efficacy and operability of the electrical components. Lid was vibration welded to lower case. Terminals were sealed to lid. A leak check was conducted to verify the integrity of housing assembly. Foam was then injected through open vent hole in lid while maintaining case at an angle of 10.5 degrees to facilitate venting of off-gasses during curing and secure a complete fill of spaces between cells. For a GC2 battery of this example, fill was 987 g, which completely covers cells. Vent was then installed on lid.

The resulting GC2 battery has a 25.8 V nominal voltage and 118 Ah nominal capacity.

### Example 2

Ten cells were electrically connected in parallel to form a group, and 16 groups of 10 cells each were electrically connected in series to form a subassembly. Two such subassemblies were prepared and electrically connected in series by the flexible current collector. The two subassemblies were folded toward one another with the current collector in the outside, and if used, a heat sink positioned between the inside faces of the two subassemblies. If an electrically conductive heat sink is used, an electrically insulating, thermally conductive interface material is placed on exposed surfaces of the cells on two open faces of subassemblies. The two subassemblies are then brought together, closed, and latched, capturing heat sink in a predetermined position between the two subassemblies.

This assembly was then placed in the lower portion of case, BMS was then attached and electrically connected to electrical connection points on assembly and on lid. An electrical check was performed to determine the efficacy and operability of the electrical components. Lid was vibration welded to lower case. Terminals were sealed to lid. A leak check was conducted to verify the integrity of housing assembly. Foam was then injected through open vent hole in lid while maintaining case at an angle of 10.5 degrees to facilitate venting of off-gasses during curing and secure complete fill of spaces between cells. For a GC2 battery of this example, fill was 987 g, which completely covers cells. Vent was then installed on the lid.

The resulting GC2 battery has a 36.9 V nominal voltage and 79 Ah nominal capacity.

### Example 3

Twelve cells were electrically connected in parallel to form a group, and 7 groups of 12 cells each were electrically connected in series to form a subassembly. Two such subassemblies were prepared and electrically connected in series by flexible current collector. The two subassemblies were folded toward one another with current collector on the outside, and if used, a heat sink positioned between the inside faces of the two subassemblies. If an electrically conductive heat sink is used, electrically insulating, thermally conductive interface material is placed on exposed surfaces of cells on two open faces of subassemblies. The two subassemblies are then brought together, closed, and latched, capturing heat sink in a predetermined position between the two subassemblies.

This assembly was then disposed in lower portion of case, BMS was then attached and electrically connected to electrical connection points on assembly on lid. An electrical check was performed to determine the efficacy and operability of electrical components. Lid was vibration welded to lower case. Terminals were sealed to lid. A leak check was conducted to verify the integrity of housing assembly. Foam was then injected through open vent hole in lid while maintaining case at an angle of 10.5 degrees to facilitate venting of off-gasses during curing and secure complete fill of spaces between cells. For a GC2 battery of this example, fill was 987 g, which completely covers cells. Vent was then installed on lid.

The resulting GC2 battery is has a 51.7 V nominal voltage and 59 Ah nominal capacity.

### Example 4

Fourteen cells were electrically connected in parallel to form a group, and 8 groups of 14 cells each were electrically connected in series to form a subassembly. Two such subassemblies were prepared and electrically connected in series by flexible current collector. The two subassemblies were folded toward one another with current collector on the outside, and if used, heat sink positioned between inside faces of two subassemblies. If an electrically conductive heat sink is used, an electrically insulating, thermally conductive interface material is placed on the exposed surfaces of the cells on the two open faces of the subassemblies. The two subassemblies were then brought together, closed, and latched, capturing heat sink in predetermined position between the two subassemblies.

This assembly was then placed in lower portion of case, BMS was then attached and electrically connected to electrical connection points on assembly and on lid. An electrical check was performed to determine the efficacy and operability of the electrical components. Lid was vibration welded to lower case. Terminals were sealed to lid. A leak check was conducted to verify the integrity of housing assembly. Foam was then injected through open vent hole in lid while maintaining case at an angle of 10.5 degrees to facilitate venting of off-gasses during curing and secure complete fill of spaces between cells. For a GC2 battery of this example, the fill was 987 g, which completely covers cells. The vent was then installed on lid.

It will be understood that before inclusion within a battery module, battery cells can be inspected. Inspection can comprise human or automated verification that each cell is free from visual defects, structural damage, that each cell is within physical measurement specifications, that each cell meets material composition or chemical specifications, and that each cell is overall suitable for inclusion in a battery module. Battery cells can also be prepared for inclusion in a battery subassembly by desleeving or removing any temporary or excess housing or packaging.

The descriptions of the various embodiments of the present disclosure have been presented for purposes of illustration and are not intended to be exhaustive or limiting. Multiple modifications and variations of the disclosed embodiments will be apparent to those of ordinary skill in the art, without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Certain features of the present disclosure, which are, for clarity, described in the context of separate embodiments, may also be combined in a single embodiment. Conversely, various features of the invention, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A battery comprising:
cells electrically connected to form a group;
groups of cells electrically connected to form first and second subassemblies;
first subassembly comprising lower tray and upper tray between which first groups of cells are disposed, and having first and second faces;
second subassembly comprising lower tray and upper tray between which second groups of cells are disposed, and having first and second faces;
a flexible current collector comprising two or more conductive regions;
first and second subassemblies electrically connected to build voltage or capacity of the battery;
the flexible current collector electrically connecting first and second subassemblies and disposed within casing to provide environmental protection to battery;
positive and negative terminals electrically connected to first and second conductive regions, respectively to form positive and negative terminals of battery; and
a battery management system electrically connected to the flexible current collector and positive and negative terminals adapted to control the flow of energy through the battery.

2. The battery of claim 1, further comprising electrically connecting the flexible current collector to first faces of the first and second subassemblies.

3. The battery of claim 2, wherein the current collector and subassemblies being folded such that the second faces of the first and second subassemblies are disposed in proximity to one another.

4. The battery of claim 3, further comprising a heat sink disposed between second faces of the first and second subassemblies.

5. The battery of claim 1, comprising a first battery further comprising using the same components to produce a second battery further comprising adding capacity by increasing the number of cells in the first and/or second subassemblies.

6. The battery of claim 1, comprising a first battery further comprising using the same components to produce a second battery further comprising reducing capacity by decreasing the number of cells in the first and/or second subassemblies.

7. The battery of claim 1, comprising a first battery further comprising a first current collector, further comprising using the same components and a second current collector comprising different conductive regions electrically connected to produce a second battery having a different voltage than said first battery.

8. The battery of claim 1, comprising a first battery further comprising a first current collector, further comprising using the same components and a second current collector comprising different conductive regions electrically connected to produce a second battery having a different capacity than said first battery.

9. The battery of claim 1, comprising a first battery comprising a first current collector, further comprising using the same components to and a second current collector comprising different conductive regions electrically connected to produce a second battery having a different voltage and the same energy than said first battery.

10. The battery of claim 1, comprising a first battery comprising a first current collector, further comprising using the same components to and a second current collector comprising different conductive regions electrically connected to produce a second battery having a different capacity and the same energy than said first battery.

11. The battery of claim 1, comprising a first battery comprising a first current collector, further comprising using the same components to and a second current collector comprising different conductive regions electrically connected to produce a second battery having a different voltage and adding capacity by increasing the number of cells in the first and/or second subassemblies.

12. The battery of claim 1, comprising a first battery comprising a first current collector, further comprising using the same components to and a second current collector comprising different conductive regions electrically connected to produce a second battery having a different voltage and decreasing capacity by decreasing the number of cells in the first and/or second subassemblies.

13. The battery of claim 1, wherein the flexible current collector further comprises one or more layers, the layers comprising:
a conductive layer comprising a pattern defining a plurality of conductive regions; and
an isolation layer; and

14. The battery of claim 1, wherein the flexible current collector further comprises one or more layers, the layers comprising:
a pressure sensitive adhesive layer;
a conductive layer comprising a pattern defining a plurality of conductive regions, and
an isolation layer.

15. The battery of claim 1, wherein the flexible current collector is electrically connected to first faces of first and second sub-assemblies by wire bonding.

16. The battery of claim 1, wherein the flexible current collector is electrically connected to first faces of first and second sub-assemblies by laser welding.

17. The battery of claim 3, wherein the flexible current collector comprises one or more bends such that the flexible current collector has a substantially “U” profile.

18. The battery of claim 1, wherein the battery further comprises:
a case configured to contain one or more subassemblies; and
a lid configured to create a seal between the lid and the case.

19. A method of assembling a battery comprising:
inserting cells into inner and outer trays of first and second carriers to form two subassemblies;
placing current collector;
electrically connecting cells to current collector; and
folding the current collector and subassemblies.

20. The method of claim 19, wherein electrically connecting cells to current collector further comprising:
wire bonding a first terminal to a first conductive region of the flexible current collector.

21. The method of claim 19, wherein folding the current collector and subassemblies further comprises:
folding the flexible current collector such that the first and second bottom cell carrier are substantially parallel to each other; and
engaging a retaining feature to retain the configuration of the first and second bottom cell carrier.

22. The method of claim 19, further comprising:
place subassemblies into case;
electrically connect battery management system to subassemblies; and
vibration welding lid to case.

23. The method of claim 19, further comprising:
attaching thermistors to one or more of the placed cells.

24. The method of claim 19, further comprising:
epoxying one or more terminals;
injecting foam into a casing; and
installing a vent to a lid.
